(19) United States
(12) Patent Application Publication
(10) Pub. No.: US 2013/0346285 A1
(43) Pub. Date: Dec. 26, 2013

(54) Facilitating Financial Institution Compliance with Foreclosure Laws

(71) Applicant: NORTH STAR AUDIT CONSULTANTS, LLC, Loganville, GA (US)

(72) Inventor: Karen Neely Louis, Roswell, GA (US)

(73) Assignee: North Star Audit Consultants, LLC, Loganville, GA (US)

(21) Appl. No.: 13/727,163

(22) Filed: Dec. 26, 2012

Related U.S. Application Data
(60) Provisional application No. 61/664,377, filed on Jun. 26, 2012.

(51) Int. Cl. G06Q 30/00

(52) U.S. Cl. CPC G06Q 30/018; G06Q 40/025
USPC 705/38

(57) ABSTRACT

A computer software application for facilitating financial institution compliance with foreclosure laws is provided. A computer may be utilized to generate a graphical user interface for initiating a loan level review of foreclosure files. During the loan level review, the computer may be utilized to identify and report missing loan file documentation and other foreclosure procedure errors, including checking for active military borrowers, bankruptcy searches and loss mitigation processes. At the completion of the review, the computer may generate a report that may be utilized in assessing compliance, following-up with the financial institution's vendors and instituting process changes.

### CROSS-REFERENCE TO RELATED APPLICATIONS

The present application claims the benefit of U.S. Provisional Patent Application No. 61/664,377 entitled “Facilitating Financial Institution Compliance with Foreclosure Laws,” filed on Jun. 26, 2012 and expressly incorporated herein, in its entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Federal and state laws require financial institutions, including banks and other mortgage lenders, to comply with various rules and regulations when foreclosing on real property. Recently, at the federal level, the Office of the Comptroller of the Currency (“OCC”) issued a requirement that national banks perform self-assessments of foreclosure practices to test their compliance. Self-assessments include a review of internal policies to make sure they comply with federal regulations and state foreclosure laws, an assessment (i.e., audit) of third-party vendors (e.g., law firms) retained to handle foreclosures, and a review of relevant foreclosure documents, etc. These self-assessments require financial institutions to prepare and answer various test questions related to foreclosure law compliance. The responses to these questions are typically entered in a chart or spreadsheet and utilized at the end of the self-assessment process to prepare a report indicating compliance (or non-compliance) with the aforementioned federal and state laws. Current methods utilized by financial institutions for determining foreclosure compliance, however, suffer from a number of drawbacks. For example, one drawback is that in assessing the compliance of third-party vendors, a determination must be made as to whether particular documents are required to complete a specific foreclosure and a calculation must be performed of a timeline of related events and benchmarks. Under current methods, the aforementioned determination and calculation are performed manually thereby increasing the risk of calculation errors and an inaccurate assessment due to the human calculation of benchmarks, the inter-relation of various statutory requirements and the timing of pre-requisite documents. For example, a foreclosure process may require that a Notice of Default (“NOD”) be sent to borrowers. The NOD may be required to be mailed to the borrowers no less than 120 days before a scheduled foreclosure sale date and posted on the collateral property. The earlier date of the mailing or posting of the NOD will be considered the NOD's issuance date. The foreclosure process may also require the completion of other documents before the NOD is issued such as statements regarding the bank's loss mitigation efforts or mediation efforts. In addition to the NOD, a Notice of Sale (“NOS”) may be required to be recorded (1) no less than 30 days after the NOD is mailed; and (2) no less than 90 days before a scheduled foreclosure sale. The NOS may also be required to be (1) published in a newspaper on multiple occasions before the foreclosure sale date; (2) posted on the collateral property no less than 90 days before the scheduled foreclosure sale; and (3) mailed to the borrowers no less than 90 days before the scheduled foreclosure sale. Given the interplay of the aforementioned various timing requirements, the likelihood of miscalculating dates is greatly increased if the aforementioned manual methods are utilized. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for facilitating financial institution compliance with foreclosure laws. The embodiments include receiving loan information from a foreclosure file being audited, querying a user for information in each of multiple sections related to a foreclosure process in the foreclosure file being audited, assigning numerical point values based on responses received to the user queries for information in each of the sections related to the foreclosure process in the foreclosure file, and performing calculations for each of the sections related to the foreclosure process in the foreclosure file to determine an indicia of compliance of the financial institution with federal and/or state foreclosure laws. The calculations may be based on a total of the assigned numerical point values and a predetermined maximum total number of numerical point values for each of the sections. The embodiments may further include generating an audit report displaying a compliance rating determined from results of the calculations performed for each of the sections in the foreclosure file. The compliance rating may be based on a predetermined threshold and indicates a level of compliance of the financial institution with federal and/or state foreclosure laws associated with the foreclosure file being audited.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a computer which may be utilized for facilitating financial institution compliance with foreclosure laws, in accordance with various embodiments;

FIG. 2 is a flow diagram illustrating a routine for facilitating financial institution compliance with foreclosure laws, in accordance with an embodiment;

FIG. 3 is a computer screen display of an application user interface which may be utilized for receiving information utilized in generating a report for facilitating financial institution compliance with foreclosure laws, in accordance with an embodiment;

FIG. 4 is a computer screen display of an application user interface which may be utilized for receiving information utilized in generating a report for facilitating financial institution compliance with foreclosure laws, in accordance with an embodiment;

FIG. 5 is a computer screen display of an application user interface which may be utilized for receiving information utilized in generating a report for facilitating financial institution compliance with foreclosure laws, in accordance with an embodiment; and

FIGS. 6A-6C are computer screen displays of a report generated for facilitating financial institution compliance with foreclosure laws, in accordance with an embodiment.

### DETAILED DESCRIPTION

Embodiments are provided for facilitating financial institution compliance with foreclosure laws. The embodiments include receiving loan information from a foreclosure file being audited, querying a user for information in each of multiple sections related to a foreclosure process in the foreclosure file being audited, assigning numerical point values based on responses received to the user queries for information in each of the sections related to the foreclosure process in the foreclosure file, and performing calculations for each of the sections related to the foreclosure process in the foreclosure file to determine an indicia of compliance of the financial institution with federal and/or state foreclosure laws. The calculations may be based on a total of the assigned numerical point values and a predetermined maximum total number of numerical point values for each of the sections. The embodiments may further include generating an audit report displaying a compliance rating determined from results of the calculations performed for each of the sections in the foreclosure file. The compliance rating may be based on a predetermined threshold and indicates a level of compliance of the financial institution with federal and/or state foreclosure laws associated with the foreclosure file being audited.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

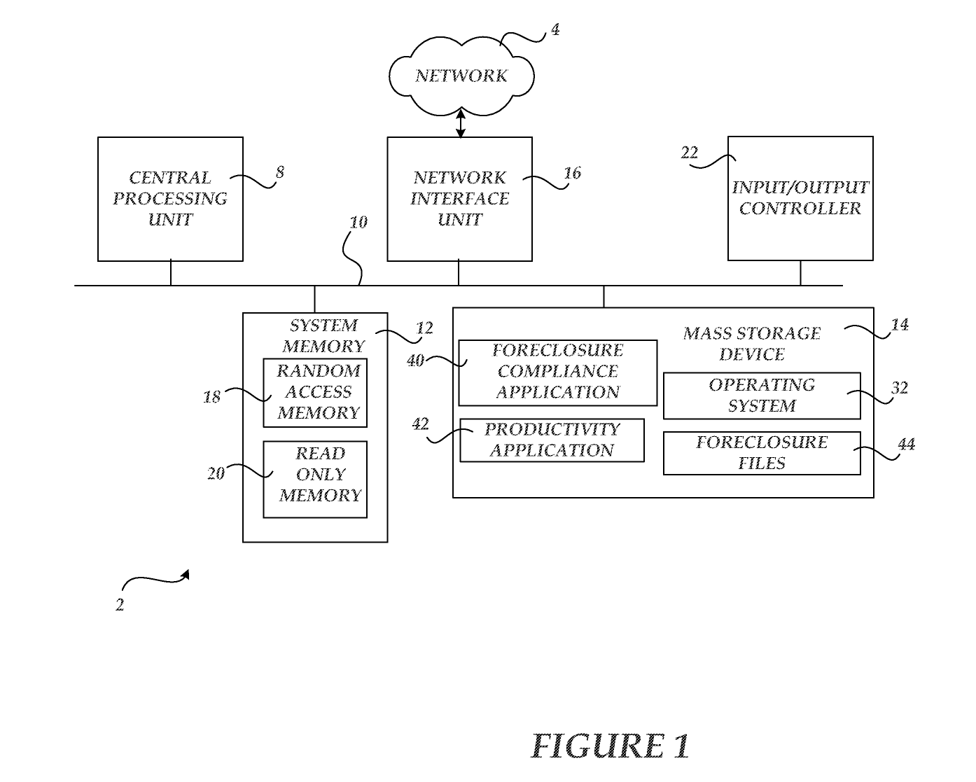

Referring now to the drawings, in which like numerals represent like elements through the several figures, various aspects of the present invention will be described. FIG. 1 and the following discussion is intended to provide a brief, general description of a suitable computing environment in which various illustrative embodiments may be implemented. While various embodiments will be described in the general context of program modules that execute in conjunction with program modules that run on an operating system on a client computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 1 shows a computer 2 which may comprise any type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

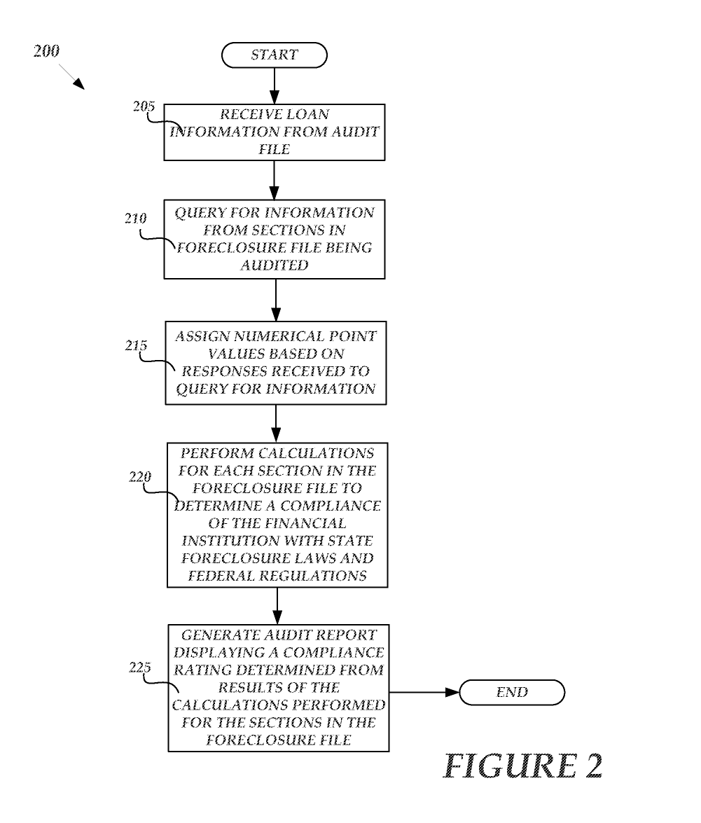

The computer 2 may further include a mass storage device 14 for storing an operating system 32, a foreclosure compliance application 40 and a productivity application 42. In accordance with various embodiments, the operating system 32 may be suitable for controlling the operation of a networked computer. In accordance with an embodiment, the foreclosure compliance application 40 may be configured to perform operations for facilitating financial institution compliance with state foreclosure laws and related federal regulations. Various operations which may be performed by the foreclosure compliance application 40 will be described in greater detail below with respect to FIGS. 2. In accordance with an embodiment, the productivity application 42 may include word processing software which may be utilized by the foreclosure compliance application 40 to generate a report following a loan level review of foreclosure files 44.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the computer 2.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments of the invention, the computer 2 may operate in a networked environment using logical connections to remote computers through network 4 which may comprise a local area network or a wide area network (i.e., the Internet). The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display device, a printer, or other type of output device. Additionally, a touch screen can serve as an input and an output mechanism.

FIG. 2 is a flow diagram illustrating a routine 200 for facilitating financial institution compliance with foreclosure laws, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 2 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 200 begins at operation 205, where the foreclosure compliance application 40 executing on the computer 2 receives loan information for a foreclosure file being audited by a user. In particular, a user may enter loan information in a graphical user interface generated by the foreclosure compliance application 40 which may include, without limitation, the state the foreclosure took place, the trustee company or law firm name that completed the foreclosure and the loan number. It should be understood that the foreclosure compliance application 40 may include or have access to various foreclosure laws which are utilized to determine compliance and generate an audit report.

From operation 205, the routine 200 continues to operation 210, where the foreclosure compliance application 40 executing on the computer 2 queries a user, in the graphical user interface, for information in each of one or more sections related to a foreclosure process in the foreclosure file being audited. In accordance with an embodiment, the sections of a foreclosure file may include, without limitation, a background documents section, a borrower notices section, a pre-foreclosure searches section, an assignments section, a pre-sale searches and notices section, and a foreclosure sale section. For example, for a background documents section, the foreclosure compliance application 40 may query the user as to whether the loan file contains various documents which may be required by state foreclosure laws and federal regulations. These documents may include, without limitation, a Deed of Trust/Security Deed containing a “power of sale” provision, a bank notification to initiate foreclosure, a copy of the Promissory Note, a copy of a title search/report, a copy of a Fair Debt Letter, a copy of the Notice of Sale, a proof of publication of the Notice of Sale, a copy of bidding instructions from the bank and a copy of a Deed Upon Power of Sale. If, during the audit, it is determined that any of the aforementioned background documents are missing, the foreclosure compliance application 40 may pause the audit and generate a message in the interface reminding the user to retrieve any missing documents. For example, the foreclosure compliance application 40 may generate a message to the user in the user interface such as “Please contact [LAW FIRM] and request the necessary documents to complete this audit. This audit will be paused while the necessary documents are requested. A reminder email with be sent to you [TODAY'S DATE PLUS 7 DAYS] to continue the audit of this loan file.” The foreclosure compliance application 40 may also be configured to save any received user response information to a database. In accordance with an embodiment, the database may comprise a Structured Query Language (“SQL”) database. The foreclosure compliance application 40 may also prompt the generation of correspondence to request the aforementioned missing document. As another example, the foreclosure compliance application 40 may also query the user as to whether various notices sent to the borrower are in compliance with state foreclosure laws and federal regulations. Illustrative queries may include, without limitation, the following: (1) whether a required notice of attorney's fees to the borrower included a required statement that the borrower has ten days from receipt to pay principal and interest without incurring the attorney's fees; (2) whether a required Notice of Sale was mailed to each borrower and/or owner at least the required fifteen days before the sale date and whether the Notice of Sale was sent using the required methods of registered or certified mail; and (3) whether a required Fair Debt letter was sent to each borrower the required five days after the mailing of the Notice of Sale. If the required background documents are contained in the loan file, the foreclosure compliance application 40 may then initiate additional queries for the purposes of adding or subtracting points (i.e., numerical point values) based on the compliance of one or more of the documents with foreclosure laws. As yet another example, the foreclosure compliance application 40 may query the user as to whether notices to the borrower were provided in compliance with state foreclosure laws and federal regulations. Illustrative queries for notices to the borrower may comprise, without limitation, the following: (1) whether the Notice of Sale contains the date, time and place for the scheduled foreclosure sale; (2) whether the Notice of Sale was published weekly for a predetermined time period; (3) whether the Notice of Sale contains a description of the property to be sold at foreclosure; and (4) whether the Notice of Sale contains a reference to a “power of sale” provision in the original Deed. The foreclosure compliance application 40 also may query the user as to whether pre-foreclosure searches were conducted in compliance with state foreclosure laws and federal regulations. Illustrative queries for pre-foreclosure searches may comprise, without limitation, the following: (1) whether a title search was performed before the property sale date; (2) whether a military search was performed before the property sale date (this is used to determine whether different state foreclosure laws and federal regulations apply to borrowers or owners who are active members of the military); and (3) whether a bankruptcy search was performed prior to the property sale date. It should be understood that, in accordance with an embodiment, the foreclosure compliance application 40 may query the user as to pre-foreclosure searches that were conducted for foreclosure files that include a Notice of Sale and for foreclosure files that do not include a Notice of Sale. As yet another example, the foreclosure compliance application 40 may query the user as to whether assignments were conducted in compliance with state foreclosure laws and regulations. Illustrative queries for assignments may include, without limitation, the following: (1) whether the foreclosure file contains an assignment to the foreclosing entity; (2) whether the assignment was signed; (3) whether the assignment was recorded and when (e.g., before or after the sale date); (4) whether the assignment was notarized and when (e.g., before or after the document was signed); (5) the expiration date of the notary's commission; (6) whether there is a power of attorney in connection with the assignment; and (7) the date the power of attorney was signed. As yet another example, the foreclosure compliance application 40 may query the user as to whether pre-sale searches were conducted and notices were communicated in compliance with state foreclosure laws and federal regulations. Illustrative queries for pre-sale searches and notices may include, without limitation, the following: (1) whether the loan is a federal loan; (2) whether there is an occupancy letter for the federal loan in the foreclosure file; (3) whether the occupancy letter for the federal loan was mailed at least sixty days before the property sale date; (4) whether the federal loan is a veteran's administration (“VA”) loan; (5) whether there is a VA appraisal in the foreclosure file; (5) whether the appraisal for the VA loan was ordered at least sixty days before the property sale date; (6) whether the appraisal and a notice of liquidation sale were sent to the VA; and (7) whether the appraisal and the notice of liquidation sale were sent to the VA prior to a VA DATE (the foreclosure compliance application 40 may be configured to calculate the VA DATE based on either thirty days before the property sale date or five days plus the date at the beginning of a first week of the publication of a notice of sale of the property, whichever is later); (8) whether an updated title search was preformed within thirty days of the property sale date; (9) whether a notice of an IRS lien was sent at least twenty-five days prior to the property sale date; and (10) whether a federal loan modification program certification was received prior the foreclosure being completed. As yet another example, the foreclosure compliance application 40 may query the user as to whether a foreclosure sale was conducted in compliance with state foreclosure laws and federal regulations. Illustrative queries for a foreclosure sale may include, without limitation, the following: (1) whether the entity taking title to the property is shown as the title holder under a Deed Under Power of Sale; (2) whether Deed Under Power of Sale was signed by an authorized person (e.g., a trustee); (3) whether the Deed Under Power of Sale was signed before the foreclosure sale took place; (4) whether the Deed Under Power of Sale was recorded and when; and (5) whether a law firm vendor prepared the appropriate deeds (e.g., a corporate grant deed or warranty deed) when the entity taking title is a government entity.

From operation 210, the routine 200 continues to operation 215, where the foreclosure compliance application 40 executing on the computer 2 may assign numerical point values based on responses received to the information queries discussed above at operation 210. For example, with respect to background documents, a state foreclosure law may require that there be proof of a Notice of Default being sent to all of the owners on the Security Deed. If, in response to a user query, the foreclosure compliance application 40 determines that the Notice of Default was not sent to all of the owners on the Security Deed, then the foreclosure compliance application 40 may subtract a point value (e.g., two points) for a Background Documents section for an audit report. If, on the other hand, the foreclosure compliance application 40 determines that the Notice of Default was sent to all of the owners on the Security Deed, then the foreclosure compliance application 40 may add a point value (e.g., two points) for a Background Documents section for an audit report. It should be understood that the foreclosure compliance application 40 may be configured to maintain both a section point total based on user responses to queries in a particular section of an audit report as well as total points (i.e., the maximum number of points which may be assigned for a particular section in the audit report). It should further be understood that there may be some instances where a section point total may have a zero or negative value based on the user responses to the queries made therein. As another example, with respect to borrower notices, the foreclosure compliance application 40 may be configured to determine whether various requirements are met based on user responses to mailing date queries for various documents in relation to mailing date requirements contained in state foreclosure laws and federal regulations accessed by the foreclosure compliance application 40. For each of the aforementioned requirements which are met or not met (based on the user responses to the aforementioned queries), the foreclosure compliance application 40 may add or subtract points (as applicable) for a borrower notices section which will be generated as part of the audit report. As yet another example, with respect to pre-foreclosure searches, the foreclosure compliance application 40 may be configured to determine whether various requirements are met based on user responses to queries made in relation to requirements contained in state foreclosure laws and federal regulations accessed by the foreclosure compliance application 40. For each of the aforementioned requirements which are met or not met (based on the user responses to the aforementioned queries), the foreclosure compliance application 40 may add or subtract points (as applicable) for a pre-foreclosure searches section which will be generated as part of the audit report. For example, points may be added if a military search was performed prior to the foreclosure sale date and points may be subtracted if a bankruptcy search was not performed prior to the foreclosure sale date. As yet another example, with respect to assignments, the foreclosure compliance application 40 may be configured to determine whether various requirements are met based on user responses to queries in relation to requirements contained in state foreclosure laws and federal regulations accessed by the foreclosure compliance application 40. For each of the aforementioned requirements which are met or not met (based on the user responses to the aforementioned queries), the foreclosure compliance application 40 may add or subtract points (as applicable) for an assignment section which will be generated as part of the audit report. For example, points may be added if the assignment is in compliance as result of the assignment being recorded on a date prior to the foreclosure sale and points may be subtracted if the assignment was notarized before the assignment document was signed. As yet another example, with respect to pre-sale searches and notices, the foreclosure compliance application 40 may be configured to determine whether various requirements are met based on user responses to queries in relation to requirements contained in state foreclosure laws and federal regulations accessed by the foreclosure compliance application 40. For each of the aforementioned requirements which are met or not met (based on the user responses to the aforementioned queries), the foreclosure compliance application 40 may add or subtract points (as applicable) for a pre-sale searches and notices section which will be generated as part of the audit report. For example, points may be added if a veteran's administration (VA) appraisal was ordered at least sixty days before the property sale date and points may be subtracted if an internal revenue service (IRS) lien notification was not sent at least twenty-five days before the property sale date. As yet another example, with respect to foreclosure sales, the foreclosure compliance application 40 may be configured to determine whether requirements are met based on user responses to queries in relation to requirements contained in state foreclosure laws and federal regulations accessed by the foreclosure compliance application 40. For each of the aforementioned requirements which are met or not met (based on the user responses to the aforementioned queries), the foreclosure compliance application 40 may add or subtract points (as applicable) for a foreclosure sale section which will be generated as part of the audit report. For example, points may be added if the entity taking title to the property is shown as the title holder under a Deed Under Power of Sale and points may be subtracted if the Deed Under Power of Sale was not recorded.

From operation 215, the routine 200 continues to operation 220, where the foreclosure compliance application 40 executing on the computer 2 performs calculations for each section in the foreclosure file to determine the compliance of a financial institution with state foreclosure laws and federal regulations. The calculations performed may include the point totals determined for each of the sections in the foreclosure file. The calculations may further include calculating a percentage of each of the section point totals based on the determined point totals for each section and the predetermined total number of possible points for that section.

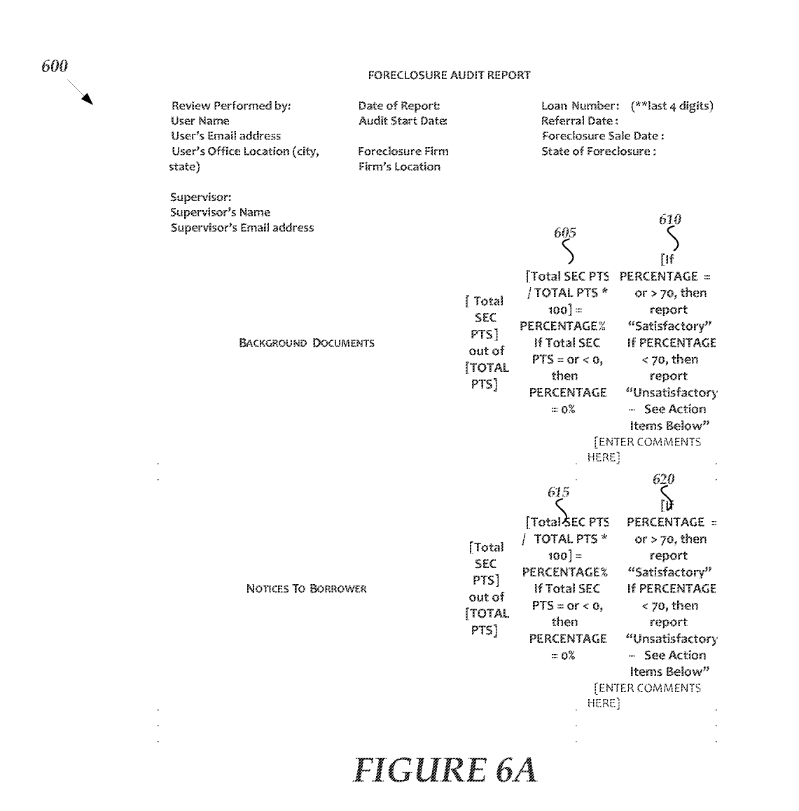

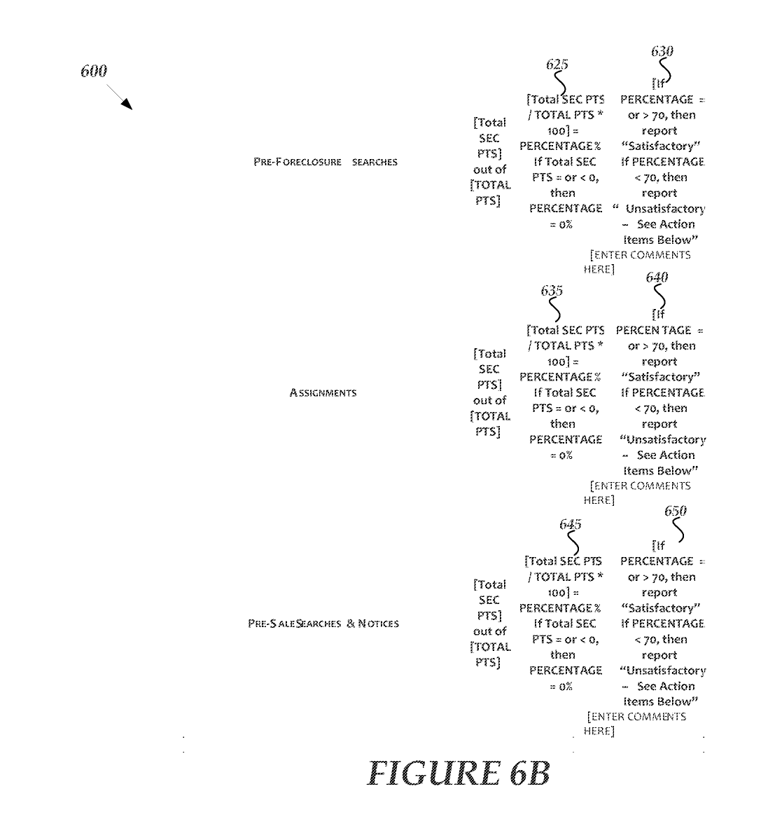

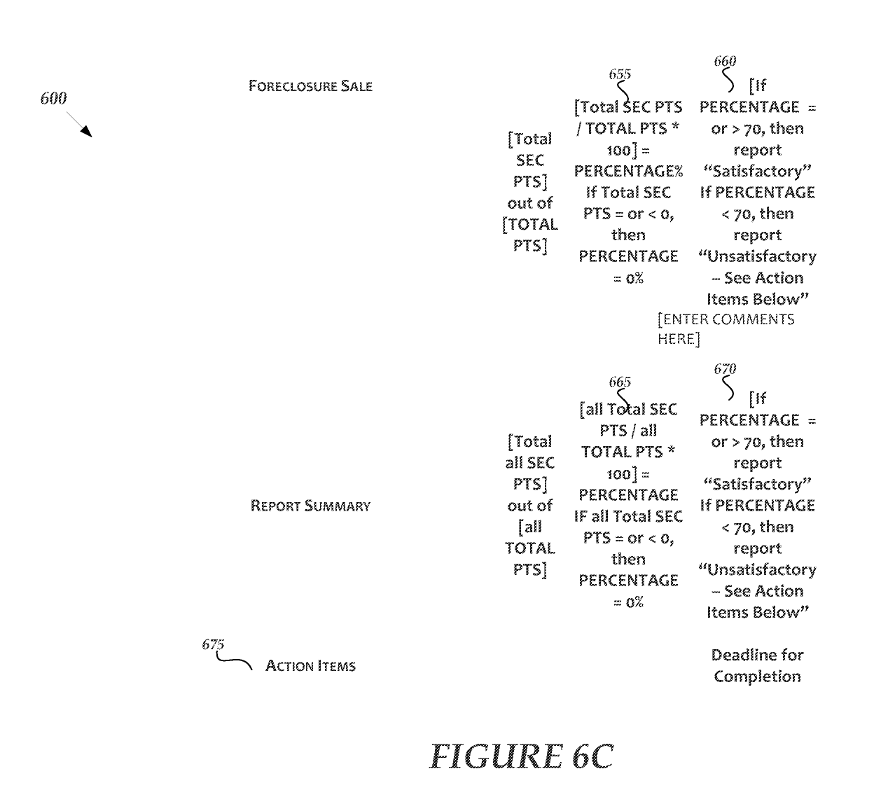

From operation 220, the routine 200 continues at operation 225 where the foreclosure compliance application 40 executing on the computer 2 generates an audit report displaying a compliance rating determined from the results of the calculations performed for the sections in the foreclosure file. The report may also display the loan information received at operation 205. An illustrative report 600 is shown in FIGS. 6A-6C. The report 600 may display calculated totals for each of the aforementioned sections as well as an overall point total for the entire report 600. The report may also display a user's (e.g., a financial institution) level of compliance with foreclosure laws based on a calculation comprising the number of section points determined based on the queries and a maximum number of total points for each section, compared to a percentage threshold, as shown in report sections 605, 610, 615, 620, 625, 630, 635, 640, 645, 650, 655, 660, 665 and 70. Thus, in accordance with an embodiment, a financial institution's foreclosure activity for a particular section may be determined to be satisfactory if the percentage of section points determined based on the section query responses is greater than a pre-determined percentage (e.g. seventy percent) of the total possible points for that section and determined to be unsatisfactory if the percentage of section points determined based on the section query responses is less than a pre-determined percentage (e.g. seventy percent) of the total possible points for that section (it should be noted that for section points which total to zero or negative values, the percentage will default to zero). For example, the foreclosure compliance application 40 may determine a section point value of six based on the user responses to the queries for pre-foreclosure searches out of a total possible point value of eight resulting in a percentage of seventy-five percent. As a result, the report 600 generated by the foreclosure compliance application 40 would report a “Satisfactory” rating, where the pre-determined threshold is seventy percentage, for the pre-foreclosure searches section of the report since the calculated percentage is greater than seventy percent. It should be understood that, in accordance with an embodiment, the foreclosure compliance application 40 may be configured to send a call to open a productivity application, such as a word processing application, so that the generated report may be viewed therein. The report 600 may also include a comment area 675 to allow a user to add freeform comments in identified columns. It should be appreciated that the foreclosure compliance application 40 may also enable users to save, print or sent the report to others via electronic mail. The foreclosure compliance application 40 may further be configured to allow other users (e.g., a supervisor) to login, access and revise a previously saved audit by entering a loan number associated with the audit being accessed. It should further be understood that the foreclosure compliance application 40 may be configured to report deficiencies identified during the audit in a predetermined section of the report 600 as well as offer guidance pursuant to foreclosure laws. For example, for the notices to borrower section of the report 600, a notice may be included which notes that a Fair Debt Letter in the file is not in the file and advises that a Fair Debt Letter should have been mailed to borrowers within five days of a vendor law firm's first contact with the borrowers. As another example, for the pre-foreclosure searches section of the report 600, a notice may included that a vendor law firm completed a foreclosure on a military service member who may have been eligible for Service Members Civil Relief Act (“SCRA”) protection and that the user (i.e., the financial institution which retained the vendor) should follow-up with the vendor law firm immediately. From operation 225 the routine 200 then ends.

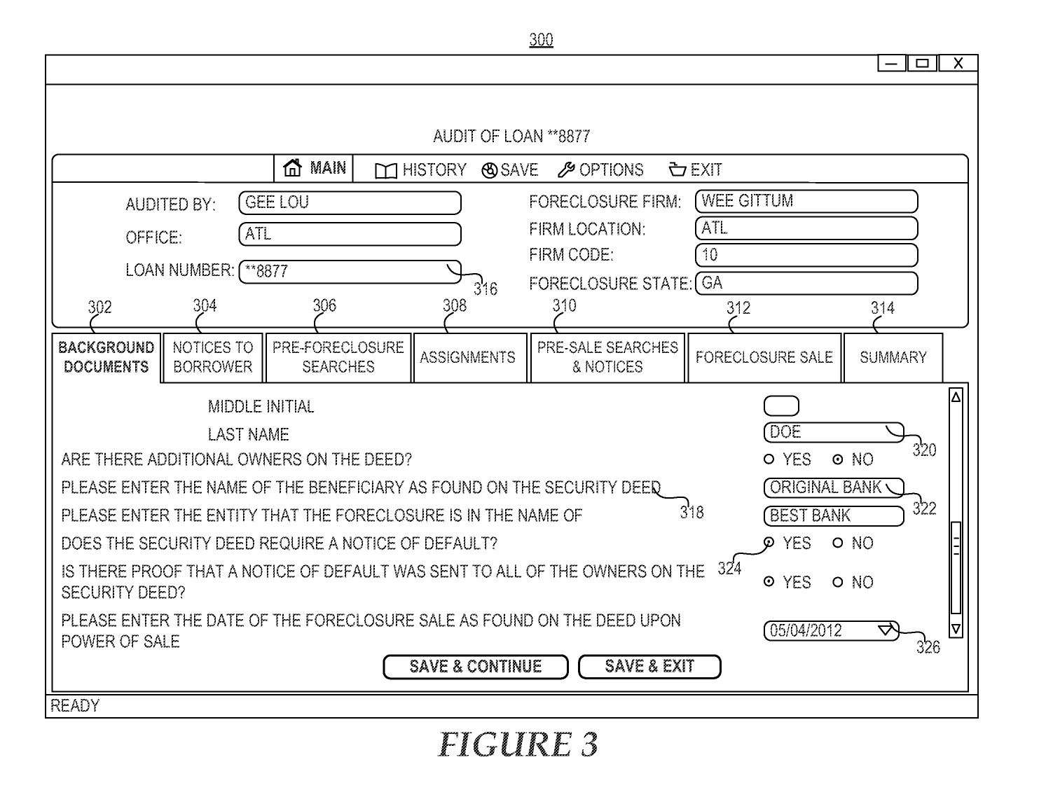

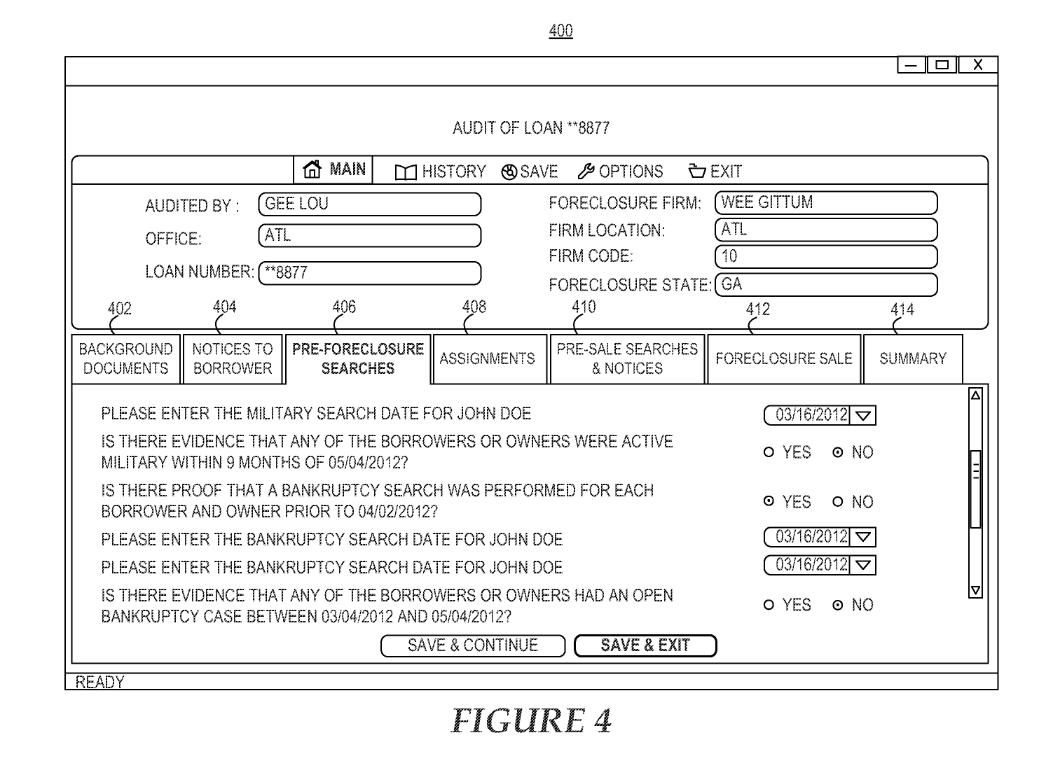

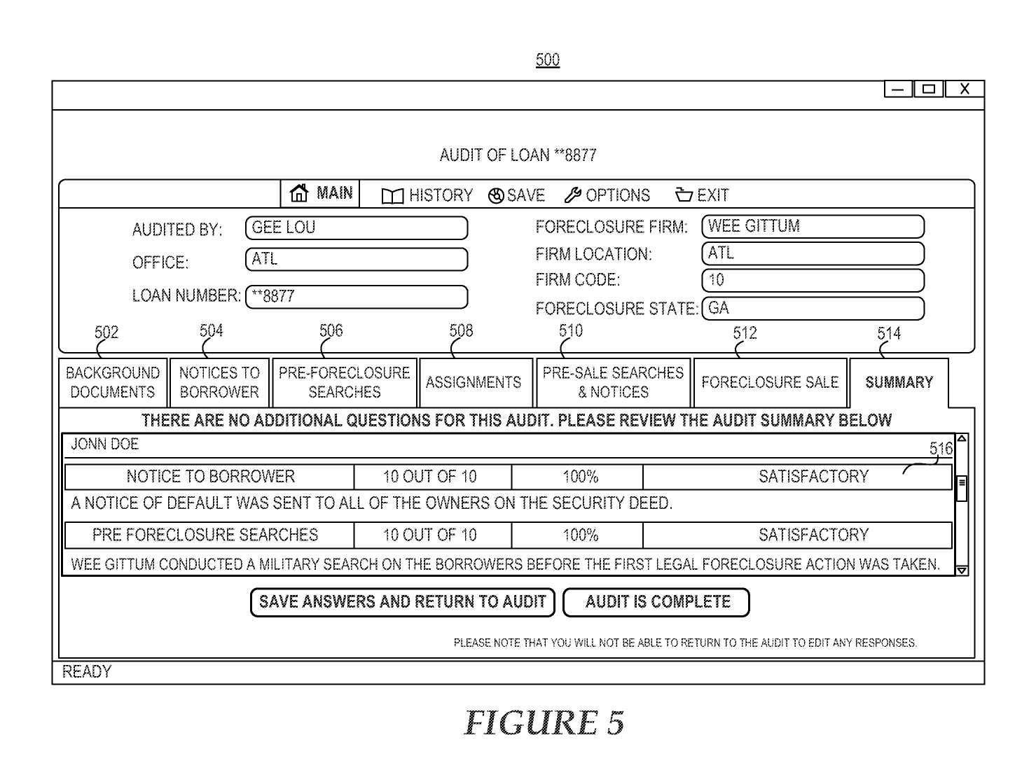

FIG. 3 is a computer screen display of an application user interface 300 which may be utilized for receiving information utilized in generating a report for facilitating financial institution compliance with foreclosure laws, in accordance with an embodiment. The application user interface 300, which may be generated by the foreclosure compliance application 40 executing on the computer 2, may include a field 316 for entering loan information as well as tabs 302-314 for entering, saving responses to queries (such as query 318) and generating a report summary (as described above with respect to FIG. 2) related to various sections of a foreclosure compliance audit. In particular, and in accordance with an embodiment, responses to queries may be entered into various user interface elements such as in fields 320 and 322, options button 324 and dropdown list 326. The tabs 302-314 may include, without limitation, Background Documents tab 302, Notices to Borrower tab 304, Pre-Foreclosure Searches tab 306, Assignments tab 308, Pre-sale Searches and Notices tab 310, Foreclosure Sale tab 312 and Summary tab 314. In the application user interface 300, the Background Documents tab 302 is selected to allow a user to respond to queries related to foreclosure background documents. It should be understood that in accordance with various embodiments, the application user interface 300 may include different and/or additional tabs based on a particular state's foreclosure laws. For example, in accordance with the foreclosure laws of some states, the application user interface 300 may include a “Complaint” tab, a “Motion for Default” tab and/or a “Judgment” tab. It should be further understood that as a result of the aforementioned different and/or additional tabs, the operations 205-240 described above with respect to FIG. 2, may also change based on any different and/or additional operations described by the different and/or additional tabs. Thus, it should be understood that the operations 205-240 described above with respect to FIG. 2, the application user interface tabs shown in FIG. 3 as well as the application user interface tabs shown and described below with respect to FIGS. 4 and 5, are illustrative only and that different or additional tabs may also be utilized without departing from the sprit and scope of the various embodiments described herein.

FIG. 4 is a computer screen display of an application user interface 400 which may be utilized for receiving information utilized in generating a report for facilitating financial institution compliance with foreclosure laws, in accordance with an embodiment. The application user interface 400, which may be generated by the foreclosure compliance application 40 executing on the computer 2, may include tabs 402-414 for entering, saving responses to queries and generating a report summary (as described above with respect to FIG. 2) related to various sections of a foreclosure compliance audit. The tabs 402-414 may include, without limitation, Background Documents tab 402, Notices to Borrower tab 404, Pre-Foreclosure Searches tab 406, Assignments tab 408, Pre-sale Searches and Notices tab 410, Foreclosure Sale tab 412 and Summary tab 414. In the application user interface 400, the Pre-Foreclosure Searches tab 406 is selected to allow a user to respond to queries related to pre-foreclosure searches.

FIG. 5 is a computer screen display of an application user interface 500 which may be utilized for receiving information utilized in generating a report for facilitating financial institution compliance with foreclosure laws, in accordance with an embodiment. The application user interface 500, which may be generated by the foreclosure compliance application 40 executing on the computer 2, may include tabs 502-514 for entering, saving responses to queries and generating a report summary (as described above with respect to FIG. 2) related to various sections of a foreclosure compliance audit. The tabs 502-514 may include, without limitation, Background Documents tab 502, Notices to Borrower tab 504, Pre-Foreclosure Searches tab 506, Assignments tab 508, Pre-sale Searches and Notices tab 510, Foreclosure Sale tab 512 and Summary tab 514. In the application user interface 500, the Summary tab 514 is selected to allow a user to view summary information related to a completed audit including whether or not specific sections of the audit were determined to be satisfactory (e.g., satisfactory rating 516) by the foreclosure compliance application 40.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or deleting operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein

What is claimed is:

1. A computer-implemented method of facilitating financial institution compliance with foreclosure laws, comprising:
receiving, by a computer, loan information from a foreclosure file being audited;
querying, by the computer, a user for information in each of a plurality of sections related to a foreclosure process in the foreclosure file being audited;
assigning, by the computer, one or more numerical point values based on responses received to the user queries for information in each of the plurality of sections related to the foreclosure process in the foreclosure file;
performing, by the computer, one or more of calculations for each of the plurality of sections related to the foreclosure process in the foreclosure file to determine a compliance of the financial institution with one or more of a set of federal regulations and state foreclosure laws, the one or more calculations being based on a total of the assigned one or more numerical point values and a predetermined maximum total number of numerical point values for each of the plurality of sections; and
generating, by the computer, an audit report displaying a compliance rating determined from results of the one or more calculations performed for each of the plurality of sections, the compliance rating being based on a predetermined threshold and indicating a level of the compliance of the financial institution with the one or more of the set of federal regulations and state foreclosure laws for the foreclosure file being audited.

2. The method of claim 1, wherein receiving, by a computer, loan information from a foreclosure file being audited comprises receiving the loan information in one or more fields in a graphical user interface.

3. The method of claim 2, wherein querying, by the computer, a user for information in each of a plurality of sections related to a foreclosure in the foreclosure file being audited comprises:
receiving, in the graphical interface, a selection of one of a plurality of tabs corresponding with the one of the plurality of sections related to the foreclosure in the foreclosure file; and
displaying one or more of the user queries for information and one or more of a plurality of graphical user interface elements for receiving the responses to the user queries for information.

4. The method of claim 3, wherein displaying one or more of the user queries for information and one or more of a plurality of graphical user interface elements for receiving the responses to the user queries for information comprises displaying one or more of a plurality of text fields, option buttons and dropdown lists.

5. The method of claim 1, wherein querying, by the computer, a user for information in each of a plurality of sections related to a foreclosure in the foreclosure file being audited comprises querying the user for information in at least two or more of a background documents section, a borrower notices section, a pre-foreclosure searches section, an assignments section, a pre-sale searches and notices section, and a foreclosure sale section.

6. The method of claim 1, wherein assigning, by the computer, one or more numerical point values based on responses received to the user queries for information in each of the plurality of sections related to the foreclosure in the foreclosure file comprises adding one or more numerical point values when a foreclosure action associated with the financial institution is in compliance with the one or more of the set of federal regulations and state foreclosure laws.

7. The method of claim 1, wherein assigning, by the computer, one or more numerical point values based on responses received to the user queries for information in each of the plurality of sections related to the foreclosure in the foreclosure file comprises subtracting one or more numerical point values when a foreclosure action associated with the financial institution is not in compliance with the one or more of the set of federal regulations and state foreclosure laws.

8. The method of claim 1, wherein generating, by the computer, an audit report displaying a compliance rating determined from results of the one or more calculations performed for each of the plurality of sections comprises displaying a satisfactory rating when the results of the one or more calculations performed for each of the plurality of sections is greater than or equal to a predetermined threshold compliance percentage.

9. The method of claim 1, wherein generating, by the computer, an audit report displaying a compliance rating determined from results of the one or more calculations performed for each of the plurality of sections comprises displaying an unsatisfactory rating when the results of the one or more calculations performed for each of the plurality of sections is less than a predetermined threshold compliance percentage.

10. The method of claim 1, wherein generating, by the computer, an audit report displaying a compliance rating determined from results of the one or more calculations performed for each of the plurality of sections further comprises:
displaying the results of the one or more calculations performed for each of the plurality of sections as a percentage and a rating for each of the plurality of sections in the foreclosure file; and
displaying a comment area for reporting deficiencies identified with one or more of the plurality of sections during the audit of the foreclosure file, the deficiencies being identified when one or more of the plurality of sections.

11. The method of claim 1, further comprising displaying, in a graphical user interface, a summary section associated with the audit report, the summary section being accessible via a tab in the graphical user interface for selection by the user and for viewing summary information related to a completed audit of the foreclosure file, the summary information including displaying one of a satisfactory rating and an unsatisfactory rating with respect to each of the plurality of sections.

12. An apparatus for facilitating financial institution compliance with foreclosure laws, comprising:
a memory for storing executable program code; and
a processor, functionally coupled to the memory, the processor being responsive to computer-executable instructions contained in the program code and operative to:
receive loan information from a foreclosure file being audited, wherein the loan information is received in one or more fields in a graphical user interface;
query a user for information in each of a plurality of sections related to a foreclosure in the foreclosure file being audited;
assign one or more numerical point values based on responses received to the user queries for information in each of the plurality of sections related to the foreclosure in the foreclosure file;
perform one or more of calculations for each of the plurality of sections related to the foreclosure in the foreclosure file to determine a compliance of the financial institution with one or more of a set of federal regulations and state foreclosure laws, the one or more calculations being based on a total of the assigned one or more numerical point values and a predetermined maximum total number of numerical point values for each of the plurality of sections; and
generate an audit report displaying a compliance rating determined from results of the one or more calculations performed for each of the plurality of sections, the compliance rating being based on a predetermined threshold and indicating a level of the compliance of the financial institution with the one or more of the set of federal regulations and state foreclosure laws for the foreclosure file being audited.

13. The apparatus of claim 12, wherein the processor, in querying a user for information in each of a plurality of sections related to a foreclosure in the foreclosure file being audited is operative to:
receive, in the graphical interface, a selection of one of a plurality of tabs corresponding with the one of the plurality of sections related to the foreclosure in the foreclosure file; and
display one or more of the user queries for information and one or more of a plurality of graphical user interface elements for receiving the responses to the user queries for information.

14. The apparatus of claim 13, wherein the one or more of a plurality of graphical user interface elements comprise one or more of a plurality of text fields, option buttons and dropdown lists.

15. The apparatus of claim 12, wherein the processor, in querying a user for information in each of a plurality of sections related to a foreclosure in the foreclosure file being audited is operative to query the user for information in at least two or more of a background documents section, a borrower notices section, a pre-foreclosure searches section, an assignments section, a pre-sale searches and notices section, and a foreclosure sale section.

16. The apparatus of claim 12, wherein the processor, in assigning one or more numerical point values based on responses received to the user queries for information in each of the plurality of sections related to the foreclosure in the foreclosure file is operative to:
add one or more numerical point values when a foreclosure action associated with the financial institution is in compliance with the one or more of the set of federal regulations and state foreclosure laws; and
subtract one or more numerical point values when a foreclosure action associated with the financial institution is not in compliance with the one or more of the set of federal regulations and state foreclosure laws.

17. The apparatus of claim 12, wherein the processor, in generating an audit report displaying a compliance rating determined from results of the one or more calculations performed for each of the plurality of sections is operative to:
display a satisfactory rating when the results of the one or more calculations performed for each of the plurality of sections is greater than or equal to a predetermined threshold compliance percentage; and
display an unsatisfactory rating when the results of the one or more calculations performed for each of the plurality of sections is less than a predetermined threshold compliance percentage.

18. The apparatus of claim 12, wherein the processor, in generating an audit report displaying a compliance rating determined from results of the one or more calculations performed for each of the plurality of sections, is operative to:
display the results of the one or more calculations performed for each of the plurality of sections as a percentage and a rating for each of the plurality of sections in the foreclosure file; and
display a comment area for reporting deficiencies identified with one or more of the plurality of sections during the audit of the foreclosure file, the deficiencies being identified when one or more of the plurality of sections.

19. The apparatus of claim 12, wherein the processor is further operative to display, in a graphical user interface, a summary section associated with the audit report, the summary section being accessible via a tab in the graphical user interface for selection by the user and for viewing summary information related to a completed audit of the foreclosure file, the summary information including displaying one of a satisfactory rating and an unsatisfactory rating with respect to each of the plurality of sections.

20. A computer-readable storage medium comprising computer executable instructions which, when executed by a computer, will cause the computer to perform a method of facilitating financial institution compliance with foreclosure laws, the method comprising:
receiving loan information from a foreclosure file being audited, wherein receiving, by a computer, loan information from a foreclosure file being audited comprises receiving the loan information in one or more fields in a graphical user interface;
querying a user for information in each of a plurality of sections related to a foreclosure in the foreclosure file being audited, the plurality of sections comprises a background documents section, a borrower notices section, a pre-foreclosure searches section, an assignments section, a pre-sale searches and notices section, and a foreclosure sale section, wherein querying a user for information in each of a plurality of sections related to a foreclosure in the foreclosure file being audited comprises:
receiving, in the graphical interface, a selection of one of a plurality of tabs corresponding with the one of the plurality of sections related to the foreclosure in the foreclosure file; and
displaying one or more of the user queries for information and one or more of a plurality of graphical user interface elements for receiving the responses to the user queries for information, wherein displaying one or more of the user queries for information and one or more of a plurality of graphical user interface elements for receiving the responses to the user queries for information comprises displaying one or more of a plurality of text fields, option buttons and dropdown lists;
assigning one or more numerical point values based on responses received to the user queries for information in each of the plurality of sections related to the foreclosure in the foreclosure file, wherein one or more numerical point values based on responses received to the user queries for information in each of the plurality of sections related to the foreclosure in the foreclosure file comprises:
adding one or more numerical point values when a foreclosure action associated with the financial institution is in compliance with the one or more of the set of federal regulations and state foreclosure laws; and
subtracting one or more numerical point values when a foreclosure action associated with the financial institution is not in compliance with the one or more of the set of federal regulations and state foreclosure laws;
performing, by the computer, one or more of calculations for each of the plurality of sections related to the foreclosure in the foreclosure file to determine a compliance of the financial institution with one or more of a set of federal regulations and state foreclosure laws, the one or more calculations being based on a total of the assigned one or more numerical point values and a predetermined maximum total number of numerical point values for each of the plurality of sections; and
generating, by the computer, an audit report displaying a compliance rating determined from results of the one or more calculations performed for each of the plurality of sections, the compliance rating being based on a predetermined threshold and indicating a level of the compliance of the financial institution with the one or more of the set of federal regulations and state foreclosure laws for the foreclosure file being audited, wherein generating an audit report displaying a compliance rating determined from results of the one or more calculations performed for each of the plurality of sections comprises:
displaying the results of the one or more calculations performed for each of the plurality of sections as a percentage and a rating for each of the plurality of sections in the foreclosure file;
displaying a comment area for reporting deficiencies identified with one or more of the plurality of sections during the audit of the foreclosure file;
displaying a satisfactory rating when the results of the one or more calculations performed for each of the plurality of sections is greater than or equal to a predetermined threshold compliance percentage; and
displaying an unsatisfactory rating when the results of the one or more calculations performed for each of the plurality of sections is less than a predetermined threshold compliance percentage.
